(19) United States
(12) Patent Application Publication
(10) Pub. No.: US 2008/0000836 A1
(43) Pub. Date: Jan. 3, 2008

(54) Transmix refining method

(76) Inventors: Hua Wang, Clifton Park, NY (US); Sean Ressell Baggott, Foothill Ranch, CA (US); Harold James Eggert, The Woodlands, TX (US); Neil Edwin Moe, Minnetonka, MN (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/479,579

(22) Filed: Jun. 30, 2006

(51) Int. Cl. C10G 31/11; B01D 61/00

(52) U.S. Cl. 210/650; 208/308; 208/177

(57) ABSTRACT

A transmix refining method comprises passing a transmix feed through a membrane to produce a permeate stream and a retentate stream without further processing the permeate stream and the retentate stream in a distillation device.

### BACKGROUND

The present disclosure generally relates to refining methods, and more particularly to transmix refining methods.

The petroleum products pipeline distribution system is the primary means of transporting liquid petroleum products within the United States. Pipelines operate in all 50 states to transport more than 19 million barrels per day of refined petroleum products to markets throughout the nation. Similar petroleum products pipeline distribution systems exist elsewhere in North America, specifically Canada, as well as in other parts of the world.

In operation, the product pipelines transport various grades of motor gasoline, diesel fuel, and aircraft turbine fuel in the same physical pipeline. Initially, the petroleum products or grades are held in separate storage facilities at the origin of the pipeline. The different types or grades of petroleum product are then transported sequentially through the same physical pipeline, through a process called “batching”. More specifically, while traversing the pipeline, a given refined product occupies the pipeline as a single batch of material. At the end of a given batch, another batch of a different petroleum product material follows. However, during transit, an interface material is created between batches. The interface or buffer material between two different pipeline products in a pipeline shipment is referred to as “transmix”. Transmix can also be created in local transit, that is, in the local piping facilities (station piping) that direct the petroleum products to and from respective destination storage tanks and in the tanks themselves.

Depending on the composition of the transmix, the transmix is purged and collected from the pipeline at the end location of the pipeline such that it may later be split into components that can be added to gasoline, diesel or the like, or, in the alternative, it can be added to the lower grade product. For example, transmix resulting from adjacent batches of different products, such as gasoline and diesel, results in an off-grade mixture that is not usable or suitable as motor fuel. This type of transmix is generally purged from the pipeline and collected such that a pure “cut” of a given product can be taken. The given product would be then stored in a separate storage vessel or facility.

For transmix resulting from adjacent batches of different grades of the same product, such as mid-grade and regular gasoline or low and high sulfur gasoline/diesel fuel, the mixture is typically blended into the lower grade. This type of “downgrading” reduces the volume of the higher quality product and increases the volume of the lower quality product. Alternatively, this transmix can also be purged and collected such that it may later be split into components that can be added to gasoline, diesel, or the like.

In a transmix refining process, the transmix is generally split into components using distillation such that the components can be added to gasoline or diesel. While distillation is successful in separating transmix products, the energy costs associated with distillation can be expensive.

Accordingly, a continual need exists for improved transmix refining methods.

### BRIEF SUMMARY

Disclosed herein are transmix refining methods.

In one embodiment, a transmix refining method comprises passing a transmix feed through a membrane to produce a permeate stream and a retentate stream without further processing the permeate stream or the retentate stream in a distillation device.

In one embodiment, a transmix refining method comprises passing a transmix feed through a membrane to produce a permeate stream and a retentate stream, wherein the permeate stream is aromatics rich and the retentate stream is aliphatics rich.

In one embodiment, a transmix refining method comprises passing a tranxmix stream through a membrane to produce a permeate stream and a retentate stream, wherein the permeate stream is aromatics rich and the retentate stream is aliphatics rich; passing the retentate stream to a distillation device; passing a hydrocarbon stream directly to the distillation device; and distilling the hydrocarbon stream and the retentate stream using the distillation device to produce a top stream and a bottom stream.

The above described and other features are exemplified by the following Figures and detailed description.

### BRIEF DESCRIPTION OF THE DRAWINGS

Referring to the exemplary drawings wherein like elements are numbered alike in the several Figures:

FIG. 1 is a schematic illustration of an embodiment of transmix refining process employing a membrane and distillation;

FIG. 2 is a schematic illustration of an embodiment of transmix refining process employing a membrane and distillation;

FIG. 3 is a schematic illustration of an embodiment of transmix refining process employing a membrane and distillation; and

FIG. 4 is a schematic illustration of an embodiment of transmix refining process employing a membrane without distillation.

### DETAILED DESCRIPTION

Disclosed herein are transmix refining methods. As will be discussed in greater detail, the transmix refining method comprises passing the transmix through a membrane. In one embodiment, the membrane pre-fractionates the transmix before distillation, which advantageously allows the transmix to be separated into higher valued products. Use of a membrane to pre-fractionate the transmix can increase throughput of a transmix refining facility compared to distillation alone. Further, in other embodiments, the membrane can replace distillation completely, thereby lowering energy costs of refining compared to distillation refining.

In the descriptions that follow, the term transmix is being used to refer to a by-product of refined products pipeline operations. For example, transmix can refer to the interface or buffer material between two different pipeline products in a pipeline shipment, which is created by the mixing of different specification products during pipeline transportation. Transmix refining methods disclosed herein split the transmix back into specification products, such as unleaded gasoline and diesel fuel.

Referring to FIG. 1, a schematic illustration of an embodiment of a method of transmix refining, generally designated 10, is illustrated. A transmix feed 12 is fed to a membrane 14, wherein the transmix feed is separated into a permeate stream 16 and a retentate stream 18. The membrane 14 comprises one or more membranes arranged in any suitable fashion. For example, the one or more membranes of the membrane 14 can be spirally wound, stacked, or the like. As is readily understood in the art, the membrane 14 can further comprise support members, end plates, and the like. The selectivity of the membrane varies depending on the desired application.

In one embodiment, the membrane 14 is an aromatic hydrocarbon selective membrane. As used herein, the term “aromatic hydrocarbon” means a hydrocarbon-based organic compound comprising at least one aromatic ring. The rings may be fused, bridged, or a combination of fused and bridged. The membrane 14 is permselective to the aromatic components. For example, when transmix is an off-grade mixture created from diesel fuel and gasoline, gasoline blending components and diesel components can be separated using the membrane 14. More particularly, the permeate stream 16 is aromatics rich, while the retentate stream is aliphatics rich. The term “rich” is being used herein to describe a concentration relative to the transmix feed 12, that is a concentration of a given component is greater in a rich stream than in the feed stream.

The membrane 14 comprises a polymer. The term polymer includes, but is not limited to, homopolymers, copolymers, terpolymers, prepolymers, polymer blends, and oligomers. For example, suitable polymers include, but are not limited to, polyesters, polyethers, polysulfones, polyimides, polyamides, polymers derived from bisphenol-A dianhydride, polyvinyl alcohols, polyacrylonitriles, polyurethanes, polyureas, polyacrylic acids, polyacrylates, elastomeric polymers such as polybutadiene, polyisoprenes, polyvinylpyridines, halogenated polymers, fluoroelastomers, polyvinyl halides, polysiloxanes, poly dimethyl siloxanes, a copolymer comprising at least one of the foregoing polymers, a blend comprising at least one of the foregoing polymers, an alloy comprising at least one of the foregoing polymers, or a combination comprising at least one of the foregoing polymers, copolymers, blends, or alloys.

In operation, the membrane 14 can generate the permeate stream 16 and the retentate stream 18 using perstractive separation techniques, pervaporation separation techniques, and the like. For example, the transmix feed 12 is passed along one side of the membrane 14 and a vacuum is applied to the membrane 14 at the opposite side so that the aromatics selectively permeate through the membrane 14 to produce the permeate stream 16. In other embodiments, the transmix feed 12 is passed along one side of the membrane 14 and a sweep gas or liquid is passed on the opposite side of the membrane 14.

An optional holding vessel 20 is in fluid communication with the permeate stream 16 such that the permeate stream 16 can be collected and stored in the holding vessel 20 for later processing or blending with gasoline. A distillation device 22 is in fluid communication with the retentate stream 18 such that the retentate stream 18 can be fed to a distillation device 22. The number of trays, reflux ratio, and the like of distillation device 22 vary depending on the composition of the retentate stream 18. The distillation device 22 separates the retentate stream 18 into a top stream 24 and a bottom stream 26. The top stream 24 comprises lighter end components that may be employed as gasoline blending components. The top stream 24 is collected and stored in a holding vessel 20 for later processing or blending with gasoline. Similarly, the bottom stream 26 is collected and stored in a holding vessel 28 for later processing or blending with diesel fuel.

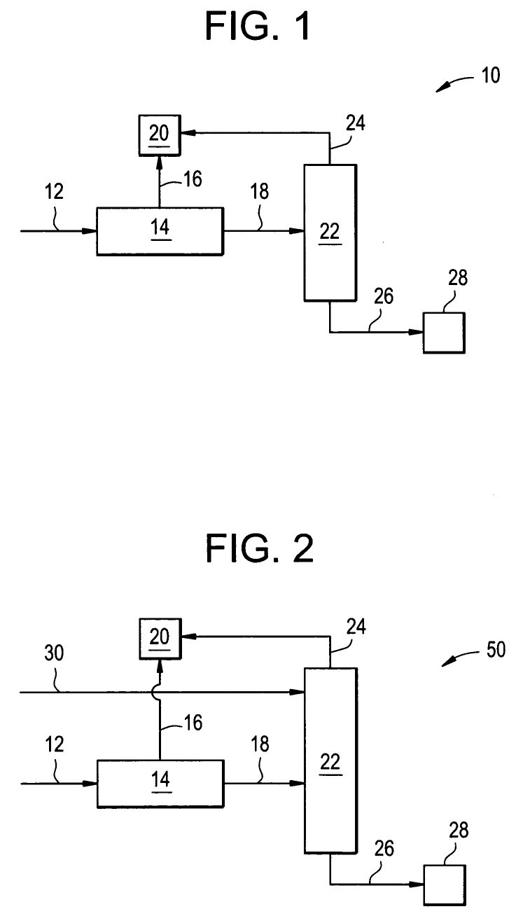

Referring to FIG. 2 with periodic reference back to FIG. 1, a schematic illustration of an embodiment of a method of transmix refining, generally designated 50, is illustrated. The method 50 illustrates an optional variation of the method 10. Transmix 12 is fed to the membrane 14, wherein it is separated into the permeate stream 16 and the retentate stream 18. The membrane 14 is operated in the manner as discussed above in relation to method 10. The holding vessel 20 is in fluid communication with the permeate stream 16. The distillation device 22 (e.g., a distillation column) is in fluid communication with the retentate stream 18, as well as another hydrocarbon feed 30. More particularly, the additional hydrocarbon feed 30 allows the distillation device 22 to utilize its maximum capacity since the permeate stream 18 has significantly lower flow rate than the original transmix feed 12.

The distillation device 22 separates the retentate stream 18 and the transmix feed into a top stream 24 and a bottom stream 26. The top stream 24 comprises lighter end components that may be employed as gasoline blending components. The top stream 24 is collected and stored in a holding vessel 20 for later processing or blending with gasoline. Similarly, the bottom stream 26 is collected and stored in an optional holding vessel 28 for later processing or blending with diesel fuel.

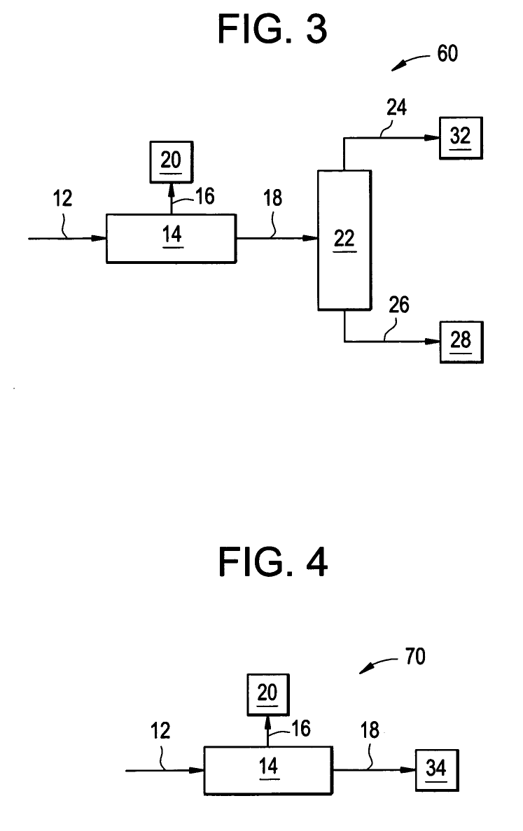

Referring to FIG. 3, a schematic illustration of an embodiment of a method of transmix refining, generally designated 60, is illustrated. The transmix feed 12 is fed to the membrane 14, wherein the transmix feed 12 is separated into the permeate stream 16 and the retentate stream 18. In this embodiment, the membrane 14 is permselective to sulfur containing compounds such that the permeate stream 16 comprises a higher sulfur concentration than the retentate stream 18. For example, the concentration of sulfur in the retentate stream 18 can be greater than or equal to two times the sulfur concentration in the transmix feed 12. The holding vessel 20 is in fluid communication with the permeate stream 16 such that the permeate stream 16 can be collected and stored in the holding vessel 20 for later processing or blending with fuel oil, diesel, kerosene, gasoline or the like. The distillation device 22 is in fluid communication with the retentate stream 18 such that the retentate stream 18 can be fed to a distillation device 22.

The distillation device 22 separates the retentate stream 18 into the top stream 24 and the bottom stream 26. The top stream 24 comprises lighter end components that may be employed as gasoline blending components with a relatively lower sulfur concentration than the sulfur concentration initially present in the transmix feed 12. The top stream 24 is collected and stored in an optional holding vessel 32 for later processing or blending with gasoline. Similarly, the bottom stream 26 is collected and stored in the holding vessel 28 for later processing or blending with diesel fuel. More particularly, the bottom stream 26 comprises diesel components having a relatively lower sulfur concentration than the sulfur concentration initially present in the transmix feed 12.

Referring to FIG. 4, a schematic illustration of an embodiment of a method of transmix refining, generally designated 70, is illustrated. The transmix feed 12 is fed to the membrane 14, wherein the transmix feed 12 is separated into the permeate stream 16 and the retentate stream 18. In this embodiment, the membrane 14 is an aromatic hydrocarbon selective membrane. More particularly, the permeate stream 16 is aromatics rich, while the retentate stream is aliphatics rich as discussed above for method 10.

The holding vessel 20 is in fluid communication with the permeate stream 16 such that the permeate stream 16 can be collected and stored in the holding vessel 20 for later processing or blending with gasoline. An optional holding vessel 34 is in fluid communication with the retentate stream 18 such that the retentate stream 18 can be collected and stored in the holding vessel 34 for later processing or blending with diesel. Advantageously, this embodiment separates transmix without further processing using a distillation device. In other words, a distillation device is not employed in method 70. Since distillation devices employ more energy that the membrane 14, significant cost savings related to energy consumption can be realized. Further, in various embodiments, the membrane 14 may be employed to reduce the sulfur composition of the transmix 12. For example, the permeate stream 16 comprises a sulfur concentration much greater than the feed 12 or retentate stream 18.

Advantageously, membranes employed in transmix refining are simple passive systems with no moving parts. They increase transmix refining capacity and represent a low investment option of refining compared to distillation. Additionally, the membranes are a modular plant technology that allows for quick deployment, as well as flexibility in refining operations. Moreover, the membranes allow the transmix to be separated into higher valued products, increase throughput of a transmix refining facility compared to distillation alone, and lower energy costs of refining compared to distillation refining.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A transmix refining method comprising:
passing a transmix feed through a membrane to produce a permeate stream and a retentate stream without further processing the permeate stream or the retentate stream in a distillation device.

2. The method of claim 1, wherein the permeate stream is aromatics rich and the retentate stream is aliphatics rich.

3. The method of claim 1, wherein the membrane comprises a polymer selected from the group consisting of polyesters, polyethers, polysulfones, polyimides, polyamides, polymers derived from bisphenol-A dianhydride, polyvinyl alcohols, polyacrylonitriles, polyurethanes, polyureas, polyacrylic acids, polyacrylates, elastomeric polymers such as polybutadiene, polyisoprenes, polyvinylpyridines, halogenated polymers, fluoroelastomers, polyvinyl halides, polysiloxanes, poly dimethyl siloxanes, and combinations comprising at least one of the foregoing.

4. The method of claim 1, wherein the permeate stream is a blending component of gasoline and the retentate stream is a blending component of diesel fuel.

5. The method of claim 1, further comprising applying a vacuum to a side of the membrane opposite a side in fluid communication with the transmix.

6. The method of claim 1, further comprising passing a sweep gas or liquid by a side of the membrane opposite a side in fluid communication with the transmix.

7. A transmix refining method comprising:
passing a transmix feed through a membrane to produce a permeate stream and a retentate stream, wherein the permeate stream is aromatics rich and the retentate stream is aliphatics rich.

8. The method of claim 7, wherein the membrane comprises a polymer selected from the group consisting of polyesters, polyethers, polysulfones, polyimides, polyamides, polymers derived from bisphenol-A dianhydride, polyvinyl alcohols, polyacrylonitriles, polyurethanes, polyureas, polyacrylic acids, polyacrylates, elastomeric polymers such as polybutadiene, polyisoprenes, polyvinylpyridines, halogenated polymers, fluoroelastomers, polyvinyl halides, polysiloxanes, poly dimethyl siloxanes, and combinations comprising at least one of the foregoing.

9. The method of claim 7, wherein the permeate stream is a blending component of gasoline and the retentate stream is a blending component of diesel fuel.

10. The method of claim 7, further comprising applying a vacuum to a side of the membrane opposite a side in fluid communication with the transmix.

11. The method of claim 7, further comprising passing a sweep gas or liquid by a side of the membrane opposite a side in fluid communication with the transmix.

12. The method of claim 7, further comprising distilling the retentate stream in a distillation device to produce a top stream and a bottom stream.

13. The method of claim 12, wherein the top stream is a blending component of gasoline and the bottom stream is a blending component of diesel fuel.

14. A transmix refining method comprising:
passing a tranxmix stream through a membrane to produce a permeate stream and a retentate stream, wherein the permeate stream is aromatics rich and the retentate stream is aliphatics rich;
passing the retentate stream to a distillation device;
passing a hydrocarbon stream directly to the distillation device; and
distilling the hydrocarbon stream and the retentate stream using the distillation device to produce a top stream and a bottom stream.

15. The method of claim 14, wherein the membrane comprises a polymer selected from the group consisting of polyesters, polyethers, polysulfones, polyimides, polyamides, polymers derived from bisphenol-A dianhydride, polyvinyl alcohols, polyacrylonitriles, polyurethanes, polyureas, polyacrylic acids, polyacrylates, elastomeric polymers such as polybutadiene, polyisoprenes, polyvinylpyridines, halogenated polymers, fluoroelastomers, polyvinyl halides, polysiloxanes, poly dimethyl siloxanes, and combinations comprising at least one of the foregoing.

16. The method of claim 14, wherein the permeate stream is a blending component of gasoline and the retentate stream is a blending component of diesel fuel.

17. The method of claim 14, further comprising applying a vacuum to a side of the membrane opposite a side in fluid communication with the transmix.

18. The method of claim 14, further comprising passing a sweep gas or liquid by a side of the membrane opposite a side in fluid communication with the transmix.

19. The method of claim 14, wherein the top stream is a blending component of gasoline and the bottom stream is a blending component of diesel fuel.
